(19) United States
(12) Patent Application Publication
(10) Pub. No.: US 2007/0022125 A1
(43) Pub. Date: Jan. 25, 2007

(54) Systems, methods, and computer program products for accumulating, strong, sharing, annotating, manipulating, and combining search results

(76) Inventors: Aly A. Salam, Smyrna, GA (US); Derek W. Ziglar, Decatur, GA (US); James Fetzer Ziglar, Decatur, GA (US)

Correspondence Address: NEEDLE & ROSENBERG, P.C., SUITE 1000, 999 PEACHTREE STREET, ATLANTA, GA, 30309-3915, US

(21) Appl. No.: 11/185,280

(22) Filed: Jul. 20, 2005

(51) Int. Cl. G06F 7/00

(52) U.S. Cl. 707/100

(57) ABSTRACT

Systems, methods, and computer program products for accumulating, storing, sharing, annotating, manipulating, and combining search results are provided. In one embodiment, a method is provided for defining a cumulative result set from a first result set and a second result set containing items which are received as a result of a first search query and second search query each submitted to one or more network accessible sources of information. In another embodiment, a method is provided for defining an intelligent result set from a first cumulative result set and a second cumulative result set. In a further embodiment, a method is provided for storing an annotation object associated with an item in a result set. In another embodiment, a method is provided for manipulating result set items by a second user. In a further embodiment, a method is provided for manipulating a first search group by a second user.

### BACKGROUND

The Internet is an immense network. As of 2005, there are more than 800 million users accessing over 8 billion pages of information, and it grows daily. That is an astounding mountain of raw data to sift through.

The Internet's greatest strength—the immense volume of information—is also the root of one of its weaknesses. Extracting specific knowledge from this vast repository of information can be frustrating and extremely time-consuming. Additionally, sites are published by thousands of people, such that there is no organization to this mass of information. Web pages are constantly added, deleted, updated, and moved. Finding relevant information on the Internet can be challenging in such a chaotic environment. Conventional search engines, such as GOOGLE.COM and YAHOO.COM, seldom find a desired answer without numerous irrelevant distractions.

There are several reasons why Internet searches are not effective. First, conventional search engines and directory services on the Internet are designed to provide instant, cursory reviews of the enormous numbers of pre-cataloged topics on the Internet. This method produces a tremendous quantity of raw and unrelated information. Conventional search engines often return unmanageably large numbers of answers to a single question. Further, conventional engines rely on stale information—sometimes weeks to months old.

Conventional search engines do not retain search results; the searcher must restart each time a search is conducted. Conventional engines work only while the searcher is online, cover a mere 20% of the available content on the Internet, only show pre-established or “canned” summaries that are frequently unrelated to the question, cannot report information that has frequently changing content, and provide no way for multiple users to store and share search results.

In order to perform a search with most search engines, a user typically submits a query containing one or more query terms. A query server program of the search engine then processes the query to identify any items that match the terms of the query. The result of the query is a result set of web sites or documents which is typically presented to the user as a hypertext listing of the located items. If the scope of the search is large, the query result may contain hundreds, thousands, or even millions of items.

Due to the enormous and rapidly growing quantity and diversity of information accessible through the Internet, search engines generally maintain a tremendous amount of Internet content and pre-index the information to facilitate rapid searching. Therefore, when an Internet user enters a search, the search engine quickly looks into its index and tries to provide the user with a response within a few seconds. The accuracy of the information provided in the response, however, depends on the current state of the index, which may be incomplete and/or outdated.

Although existing search engines are generally useful, users interested in acquiring and compiling focused information are often inundated with too many results. Moreover, prior art search engines are ill equipped to handle the formidable task of indexing the vast amounts of developing Internet content. Indeed, because existing search engines are tailored to give users immediate responses, those responses are often inaccurate, irrelevant, and/or antiquated. The user ultimately takes the brunt of any errors, inaccuracies, and outdated information. Specifically, users are often presented with duplicative search results (i.e., the same found item may appear on one or more different web sites), or dead links (which generate the dreaded “Error 404”, which means that the information, although indexed, is no longer available at the site that generated the index entry). In addition, search engines provide only one tool for actually conducting an internet research.

Human beings traditionally conduct research in a manner that is not facilitated by present Internet search engines. Just like in conventional library research, people typically conduct research by (1) attempting to identify one or more authoritative sources of information, (2) locating and querying those sources, (3) inspecting manageable collections of information returned by those sources, (4) comparing the result sets provided by each source, (5) taking notes on the information (e.g. by writing on an index card), (6) “filtering” the information by categorizing the cards as a function of quality or state of currency or completeness, etc., (7) selecting and retaining those items of information that satisfy the researcher's goals, (8) repeating the previous steps as necessary to achieve sufficient information to meet both initial research goals, and (9) sharing individual search results, result sets, and notes with other researchers. Unfortunately, no method exists which provides this functionally for a user searching network accessible sources of information such as Internet search engines.

As described above, existing Internet search engines only provide the user with a list of possible sources of information (i.e., a list of static items that have been indexed a day, a week, or may be a month ago). The list provided by an existing search engine is much like providing a library user with a listing from a card catalog. For example, like a card catalog, a list of sources only informs the user that there may be information available on a particular research topic. It does not provide the user with any additional assistance. The user is left to hunt down whether the information is still available and if so, determine whether it is truly relevant to the researched query.

Furthermore, while existing Internet search engines provide instantaneous responses, they do not provide users with any continuity of use, adequate means for filtering the irrelevant information, adequate means for comparing result sets, adequate means for annotating results, adequate means for retaining relevant findings, or adequate means for sharing information. In other words, prior art search engines do not maintain a relationship with any one user and are therefore unable to identify one user from another. Accordingly, when a user enters a follow-up search request to obtain updated information from a past search, existing search engines will likely reproduce duplicate items. The user must then sort through all the duplicate items to determine if the search results contain any new or updated information. This has proven a difficult and tedious task for serious Internet researchers.

Therefore, what is needed is a searching tool which submits queries to one or more network accessible sources of information such as Internet search engines, receives and stores results, processes the results, and combines the result sets into a cumulative result set. There is also a need for a searching tool which can combine two or more cumulative result sets to define an intelligent result set.

There is further a need to allow a network researcher to store annotations regarding items in search result sets. There also exists a need to allow a user to define a search group comprising one or more network search queries and one or more search result sets. Correspondingly, there is a need for multiple users to share items in search results, annotations, and search groups using access permissions, providing controlled network research collaboration.

### SUMMARY OF THE INVENTION

Briefly described, the present invention relates to methods, systems, and computer program products for conducting computerized research using one or more network accessible sources of information, and operates in a manner similar to that of a human searcher in a library. A system constructed in accordance with the present invention helps a user utilize the internet as a database of knowledge. One embodiment of the present invention compiles information from multiple sources, weeds out obviously bad information, and combines two or more search results sets into one or more cumulative result sets. A further embodiment of the present invention combines two or more cumulative result sets into one or more intelligent result sets, provides for user determined annotations associated with items, provides search groups, and provides for multi-user sharing of items, result sets, cumulative results sets, intelligent result sets, search groups, and annotations.

In one embodiment of the present invention, a method is provided wherein a user defines a cumulative result set as a function of two or more search result sets. For example, a user wishes to compare and contrast the search results generated from the search queries COCA-COLA and DIET COKE, so that the user can determine the network accessible sources of information which mention both COKE products. As used in the present application, network accessible sources of information includes network searchable sources of information such as intranet search engines, internet search engines such as YAHOO.COM, network accessible databases, file transfer protocol (FTP) sites, bulletin boards, discussion forums, web pages, digital files, email messages, and any other network accessible source.

Using the method of one embodiment of the present invention, the user defines a first search query, COCA-COLA, and a second search query, DIET COKE, and stores the first and second search queries. Next, the method submits the first search query to one or more network accessible sources of information, and receives a first raw result set containing one or more items which are associated with network addresses. As used in the present application, items includes web pages, graphics files, applets, plug-ins, multimedia files, database records, text or binary documents, or any other type of information object.

The method of the current embodiment then submits the second search query to one or more network accessible sources of information, and receives a second raw result set containing one or more items which are associated with network addresses. As used in the present application, the term network address includes Universal Resource Locators (URLs), Internet Protocol (IP) addresses, Universal Datagram Packet (UDP) addresses, Media Access Control (MAC) addresses, and any other means for locating an item or source of items on a wired, wireless, or optical network.

The method of the present embodiment then stores, as a first result set, a selected subset of the first raw result set, and stores, as a second result set, a selected subset of the second raw result set. As used in the present application, the term selected subset means the proper subset of a given set, comprising zero to all elements of the input set. In the present embodiment, the selected subsets may be formed from raw result sets by eliminating duplicate items and dead links, as well as by removing items which are associated with an item or address exclusion list.

Next in the current embodiment, the first result set and the second result set are stored. In the present application, storing or storage includes temporarily or permanently storing data in a volatile or non-volatile memory, cache, hard disk, removable media (including magnetic media such as floppy disks, optical disks, non-volatile removable memory devices such as flash memory cards, etc.), and hardware device buffers. Then, a function is next executed which has as its input at least the first result set generated from the COCA-COLA search query, and the second result set generated from the DIET COKE search query.

The function performs one or more operations on the first and second result sets, including set operations such as select, project, join, union, difference, or intersection functions, as well as Boolean logic or other functions. Since the user of the current embodiment desires to see result listings which mention both COCA-COLA and DIET COKE, the function performs a set operation on the first result set and the second result set, defining a cumulative result set which only contains results which contain both COCA-COLA and DIET COKE. The present embodiment then communicates the cumulative result set to the user, such as by displaying the cumulative result set in the user's web browser or emailing the results to the user. Additionally, the user may also store the cumulative result set for further use, annotate cumulative result set items, share the results with other users, or include the results in a search group.

In another embodiment, the present invention provides a method for defining an intelligent result set as a function of a first and second cumulative result set. First, a user defines one or more queries in a first query set, such as COKE and DIET COKE. Then, the user defines one or more queries in a second query set, such as PEPSI and DIET PEPSI. The method of the current embodiment then submits each query to one or more network accessible sources of information, and stores, for each query, a cumulative result set comprising a selected subset of the raw search results received from each source of information. Here, for example, the user wishes to compare the cumulative result set which contains both COKE products, and the cumulative result set which contains PEPSI products, so the selected subset is created by performing a set function such as an intersection function on the first and second cumulative result sets. The intelligent result set defined in this embodiment has many uses, including market research, financial research, competitive intelligence, trademark enforcement, and brand analysis.

In yet another embodiment of the present invention, a method is provided for storing annotation objects, allowing a user to make and store ‘notes’ for a result set, one or more items in a result set, or for a search group. Like a library user making note cards for each relevant source, or a student making annotations in the margins of a book, the ability to make notes regarding particular result set items is invaluable to a user. An annotation object thus allows a user to make a personal note or summary, in their own words, concerning a particular item, such as remarks about its content, usefulness, relevance, or simply to mark it for further review.

A further embodiment of the present invention enables a first user to share their annotations with a second user. This allows the second user to benefit from the first user's personal review and analysis of result items, keeping the second user from having to “re-invent the wheel” and spend hours reviewing stored search results.

Yet another embodiment of the present invention provides a method for a first user to share result set items with a second user in a controlled fashion according to an access permission. For example, suppose a first user has created a very useful query and corresponding search result set. The first user wishes to share her results with a colleague, who may also find the results very useful. This embodiment of the present invention allows the first user to select a first result set which contains one or more items or search results, and define access permissions which dictate the level of access a second user has to the result items. In this example, the first user defines an access permission which gives her colleague read-only access to the result items, enabling her colleague to read and benefit from, but not modify, one or more items in the first user's result set.

In another embodiment of the present invention, a method is provided which allows a first user to define access permissions for a second user, enabling the second user to manipulate a first search group. A search group can include one or more search queries, result sets, and annotation objects, and is similar to a research book shelf or work group. In the current embodiment, for example, the first user defines a first search group associated with a first search query and a first result set. So that the first user can share the search group with a second user, the fist user defines a first access permission which defines the level of access that the second user has to the first search group. For example, suppose that the first and second users share a common research goal, wherein the first user has conducted a search using the search query “A AND B NOT C.” To share his results and enable the second user to contribute to the search effort, the first user defines an access permission giving the second user read and modify access to the first search group. Accordingly, the second user uses a web browser to accesses the first search group and see the first user's existing query. Then, according to the access permission, the second user modifies the query to “A AND B NOT C AND D”, creating a more useful query for the first and second user's common research task.

Additionally in the current embodiment, the first user may define, store, and associate an annotation object with one or more items or queries in the first search group, enabling the first and second user to make and share notes on queries or results in the search group. For example, the first user may create an annotation object associated with a result item, reading “Great Source!” When the second user then reads that annotation object, according to an access permission, he immediately knows that the annotated object is an item worth reading.

It will be apparent to those skilled in the art that various devices may be used to carry out the system and method of the present invention, including cell phones, personal digital assistants, wireless communication devices, or dedicated hardware devices designed specifically to carry out the system and method of the present invention. The various embodiments of the present invention, while disclosing a logical order of steps performed, are not intended in any way to be limited to the order in which those steps are recited in the present application. Furthermore, while various embodiments provided in the current application refer to the invention classes of methods, systems, or computer program products, it should be noted that the present invention may be carried out, embodied, or claimed in any statutory class.

Other goals, features, and advantages of the present invention will become apparent upon reviewing the following detailed description of the preferred embodiments of the invention, when taken in conjunction with the drawings and the appended claims.

### BRIEF DESCRIPTION OF THE DRAWINGS

The accompanying drawings, which are incorporated in and constitute part of this specification, illustrate embodiments of the invention, and together with the description, serve to explain the principles of the invention. The embodiments described in the drawings and specification in no way limit or define the scope of the present invention.

FIG. 1 illustrates a logical overview of one embodiment of the present invention drawn to determining a cumulative result set.

FIG. 2 illustrates a logical overview of one embodiment of the present invention wherein a subset is selected.

FIG. 3 illustrates one embodiment of the present invention wherein a cumulative result set is formed from a first result set and a second result set.

FIG. 4 illustrates another embodiment of the present invention wherein a cumulative result set is formed from a first result set and a second result set.

FIG. 5 illustrates a logical overview of one embodiment of the present invention drawn to determining an intelligent result set.

FIG. 6A illustrates a logical overview of another embodiment of the present invention drawn to determining an intelligent result set.

FIG. 6B continues the logical overview of the embodiment of FIG. 6A drawn to determining an intelligent result set.

FIG. 7 shows the determination of an intelligent result set in one embodiment from a first cumulative result set and a second cumulative result set.

FIG. 8 illustrates the determination of an intelligent result set in another embodiment from a first cumulative result set and a second cumulative result set.

FIG. 9 illustrates a logical overview of one embodiment of the present invention for storing annotation objects.

FIG. 10 illustrates a logical overview of another embodiment of the present invention for storing annotation objects.

FIG. 11 illustrates a logical overview of one embodiment of the present invention for storing and sharing annotation objects.

FIG. 12 illustrates a logical overview of one embodiment of the present invention for manipulating result set items.

FIG. 13 illustrates a logical overview of one embodiment of the present invention for manipulating and sharing result set items.

FIG. 14 shows a logical overview of a computer system which may be used to carry out the various embodiments of the present invention.

FIG. 15 illustrates a logical overview of one embodiment of the present invention for manipulating a search group.

FIG. 16 illustrates a logical overview of one embodiment of the present invention for manipulating and annotating a search group.

FIG. 17 illustrates a logical overview of one embodiment of the present invention for manipulating and sharing annotations for a search group.

FIG. 18 shows a screen capture of one embodiment of the present invention, illustrating at least search groups, intelligent result sets, and collaborative research.

FIG. 19 shows a screen capture of one embodiment of the present invention, illustrating at least a search group and result set sharing.

FIG. 20 shows a screen capture of one embodiment of the present invention, illustrating at least search group sharing.

FIG. 21 shows a screen capture of one embodiment of the present invention, illustrating at least user access permissions.

FIG. 22 shows a screen capture of one embodiment of the present invention, illustrating at least search group collaboration.

FIG. 23 shows a screen capture of one embodiment of the present invention, illustrating at least a search group, means for communicating results to a user, search queries, result sets, and an intelligent result set.

FIG. 24 shows a screen capture of one embodiment of the present invention, illustrating at least a search group, result item, and annotation object.

FIG. 25 illustrates logically the arrangement of computers connected to the Internet in one embodiment of the present invention.

FIG. 26 shows a screen capture of one embodiment of the present invention, illustrating at least a search group, search queries, stored search results, annotation objects, and a cumulative result set.

### DETAILED DESCRIPTION

Before the present methods, systems, and computer program products are disclosed and described, it is to be understood that this invention is not limited to specific methods, specific components, or to particular compositions, as such may, of course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Thus, for example, reference to “an encoder” includes mixtures of encoders, reference to “an encoder” includes mixtures of two or more such encoders, and the like.

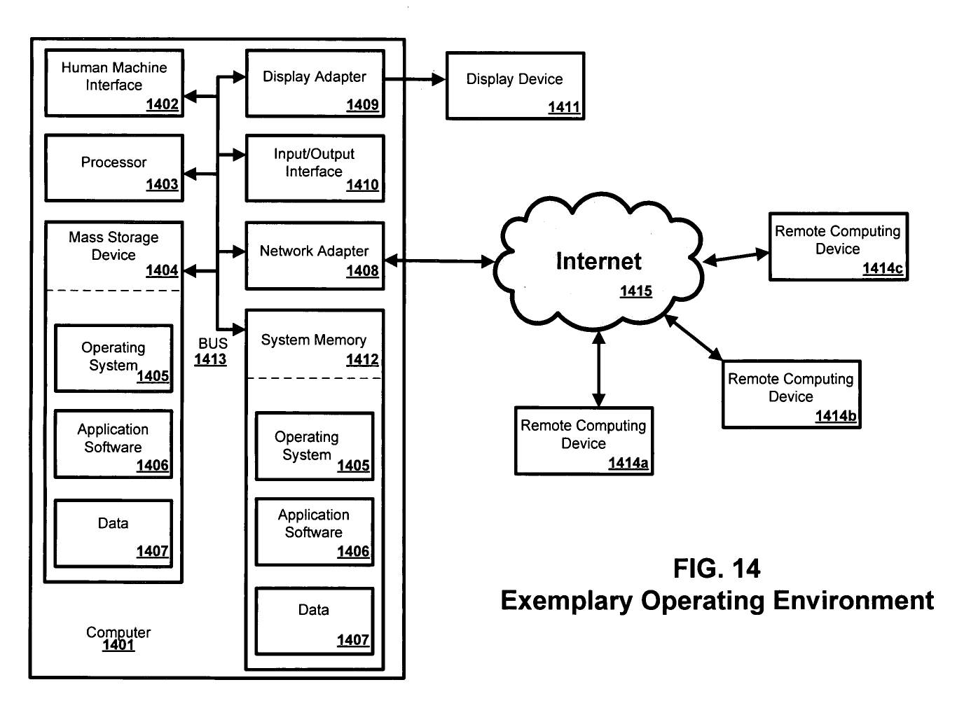

The system, method, and computer program product of the present invention, collectively referred to herein as the “method” or “methods” of the present invention, can be carried out using a processor programmed to carry out the various embodiments of the present invention. FIG. 14 is a block diagram illustrating an exemplary operating environment for performing the disclosed method. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The method can be operational with numerous other general purpose or special purpose computing system environments or configurations. Examples of well known computing systems, environments, and/or configurations that may be suitable for use with the method include, but are not limited to, personal computers, server computers, laptop devices, and multiprocessor systems. Additional examples include set top boxes, programmable consumer electronics, network PCs, minicomputers, mainframe computers, distributed computing environments that include any of the above systems or devices, and the like.

The method may be described in the general context of computer instructions, such as program modules, being executed by a computer. Generally, program modules include routines, programs, objects, components, data structures, etc. that perform particular tasks or implement particular abstract data types. The method may also be practiced in distributed computing environments where tasks are performed by remote processing devices that are linked through a communications network. In a distributed computing environment, program modules may be located in both local and remote computer storage media including memory storage devices.

The method disclosed herein can be implemented via a general-purpose computing device in the form of a computer 1401. The components of the computer 1401 can include, but are not limited to, one or more processors or processing units 1403, a system memory 1412, and a system bus 1413 that couples various system components including the processor 1403 to the system memory 1412.

The processor 1403 in FIG. 14 can be an x-86 compatible processor, including a PENTIUM IV, manufactured by Intel Corporation, or an ATHLON 64 processor, manufactured by Advanced Micro Devices Corporation. Processors utilizing other instruction sets may also be used, including those manufactured by Apple, IBM, or NEC.

The system bus 1413 represents one or more of several possible types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus. This bus, and all buses specified in this description can also be implemented over a wired or wireless network connection. The bus 1413, and all buses specified in this description can also be implemented over a wired or wireless network connection and each of the subsystems, including the processor 1403, a mass storage device 1404, an operating system 1405, application software 1406, data 1407, a network adapter 1408, system memory 1412, an Input/Output Interface 1410, a display adapter 1409, a display device 1411, and a human machine interface 1402, can be contained within one or more remote computing devices 1414a,b,c at physically separate locations, connected through buses of this form, in effect implementing a fully distributed system.

The operating system 1405 in FIG. 14 includes operating systems such as MICROSOFT WINDOWS XP, WINDOWS 2000, WINDOWS NT, or WINDOWS 98, and REDHAT LINUX, FREE BSD, or SUN MICROSYSTEMS SOLARIS. Additionally, the application software 1406 may include web browsing software, such as MICROSOFT INTERNET EXPLORER or MOZILLA FIREFOX, enabling a user to view HTML, SGML, XML, or any other suitably constructed document language on the display device 1411.

The computer 1401 typically includes a variety of computer readable media. Such media can be any available media that is accessible by the computer 1401 and includes both volatile and non-volatile media, removable and non-removable media. The system memory 1412 includes computer readable media in the form of volatile memory, such as random access memory (RAM), and/or non-volatile memory, such as read only memory (ROM). The system memory 1412 typically contains data such as data 1407 and and/or program modules such as operating system 1405 and application software 1406 that are immediately accessible to and/or are presently operated on by the processing unit 1403.

The computer 1401 may also include other removable/non-removable, volatile/non-volatile computer storage media. By way of example, FIG. 14 illustrates a mass storage device 1404 which can provide non-volatile storage of computer code, computer readable instructions, data structures, program modules, and other data for the computer 1401. For example, a mass storage device 1404 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules can be stored on the mass storage device 1404, including by way of example, an operating system 1405 and application software 1406. Each of the operating system 1405 and application software 1406 (or some combination thereof) may include elements of the programming and the application software 1406. Data 1407 can also be stored on the mass storage device 1404. Data 1404 can be stored in any of one or more databases known in the art. Examples of such databases include, DB2®, Microsoft® Access, Microsoft® SQL Server, Oracle®, mySQL, PostgreSQL, and the like. The databases can be centralized or distributed across multiple systems.

A user can enter commands and information into the computer 1401 via an input device (not shown). Examples of such input devices include, but are not limited to, a keyboard, pointing device (e.g., a “mouse”), a microphone, a joystick, a serial port, a scanner, and the like. These and other input devices can be connected to the processing unit 1403 via a human machine interface 1402 that is coupled to the system bus 1413, but may be connected by other interface and bus structures, such as a parallel port, serial port, game port, or a universal serial bus (USB).

A display device 1411 can also be connected to the system bus 1413 via an interface, such as a display adapter 1409. For example, a display device can be a cathode ray tube (CRT) monitor or an Liquid Crystal Display (LCD). In addition to the display device 1411, other output peripheral devices can include components such as speakers (not shown) and a printer (not shown) which can be connected to the computer 1401 via Input/Output Interface 1410.

The computer 1401 can operate in a networked environment using logical connections to one or more remote computing devices 1414a,b,c. By way of example, a remote computing device can be a personal computer, portable computer, a server, a router, a network computer, a peer device or other common network node, and so on. Logical connections between the computer 1401 and a remote computing device 1414a,b,c can be made via a local area network (LAN) and a general wide area network (WAN). Such network connections can be through a network adapter 1408. A network adapter 1408 can be implemented in both wired and wireless environments. Such networking environments are commonplace in offices, enterprise-wide computer networks, intranets, and the Internet 1415.

For purposes of illustration, application programs and other executable program components such as the operating system 1405 are illustrated herein as discrete blocks, although it is recognized that such programs and components reside at various times in different storage components of the computing device 1401, and are executed by the data processor(s) of the computer. An implementation of application software 1406 may be stored on or transmitted across some form of computer readable media. An implementation of the disclosed method may also be stored on or transmitted across some form of computer readable media. Computer readable media can be any available media that can be accessed by a computer. By way of example, and not limitation, computer readable media may comprise “computer storage media” and “communications media.” “Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

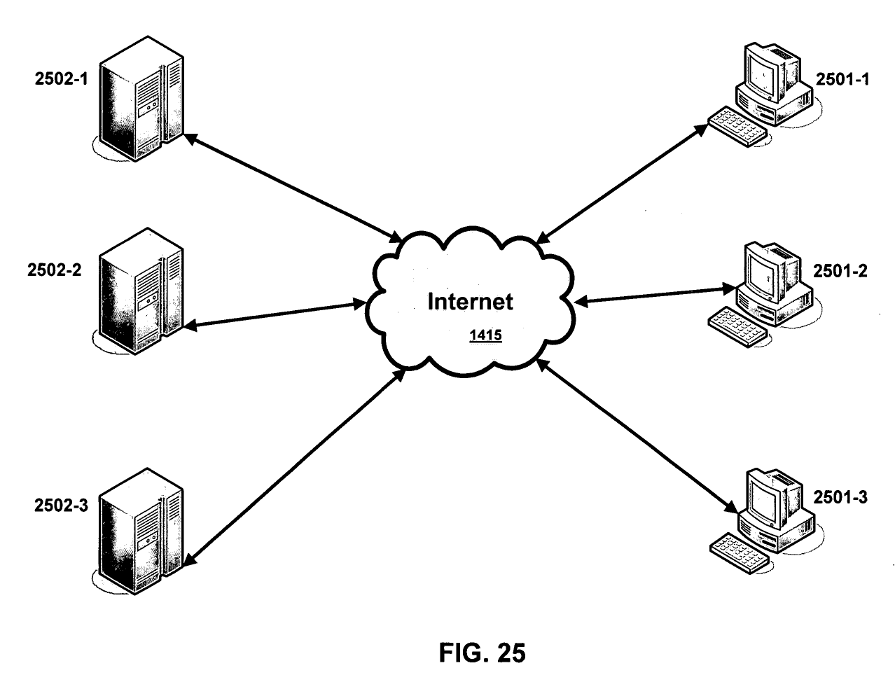

FIG. 25 illustrates a logical overview of the Internet 1415 of one embodiment of the present invention. One or more client computers 1401, for example, such as the remote computing devices 1414a,b,c depicted in FIG. 14, may be connected to the Internet 1415 as depicted at 2501-1, 2501-2, and 2501-3. Additionally, one or more computers 2502-1, 2502-2, and 2502-3 of the type depicted at 1401 may act as servers, providing web pages via HTTP request, database access, remote terminal services, digital file download or upload, or any other desired service. Furthermore, one or more client computers, such as 2501-1, may act as an Internet accessible server computer 2502-1, and vice versa.

It will be apparent to those skilled in the art that various devices may be used to carry out the system, method, or computer program product of the present invention, including cell phones, personal digital assistants, wireless communication devices, or dedicated hardware devices designed specifically to carry out the present invention.

Unless otherwise expressly stated, it is in no way intended that any method or embodiment set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of embodiments described in the specification.

### Research Using a Cumulative Result Set

In one embodiment of the present invention, a method is provided for facilitating network research using cumulative result sets. Cumulative result sets are useful for research by allowing a user to query network accessible sources of information, receive and store result sets, and then compare and contrast those result sets using functions such as set operations. By storing and comparing result sets to produce cumulative result sets, the present invention allows the Internet to be used as a powerful database-like research tool, with functionality far beyond that of traditional search engines.

The current embodiment is useful for conducting competitive intelligence on the Internet. For example, suppose a researcher wants to conduct competitive intelligence on COCA-COLA products. To do so, the researcher first defines and stores a query and corresponding result set for one or more individual COCA-COLA products, such as COKE and DIET COKE. Storing a result set for each product is useful because it allows the researcher to analyze results for an individual product, persistently store those results for further review and research, as well as compare and contrast one result set with another, yielding invaluable research information.

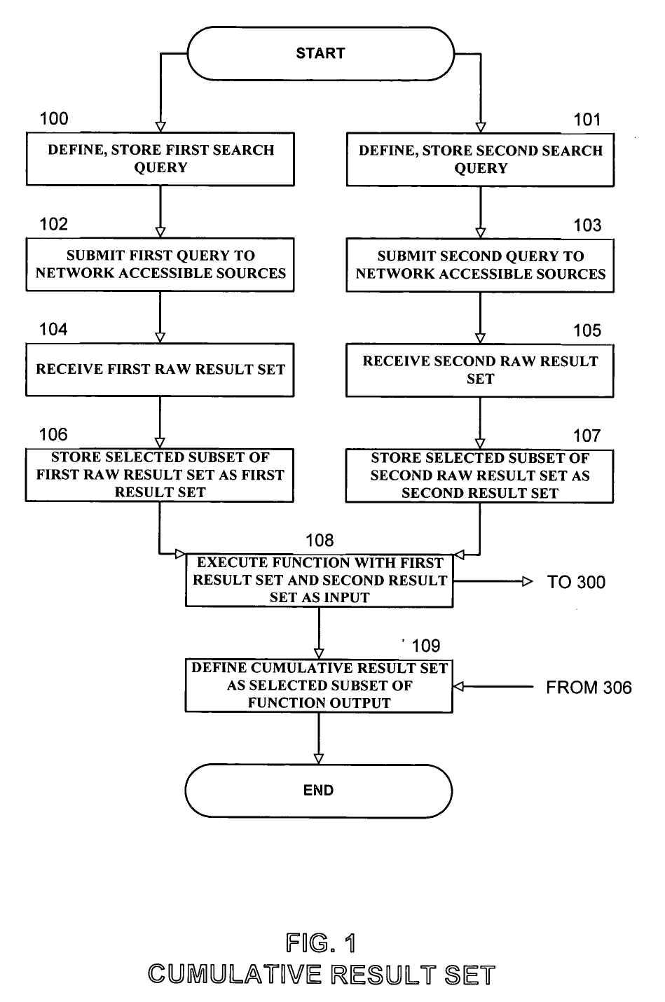

Applying the present embodiment to the illustrative example for COCA-COLA products given above, a logical overview for defining a cumulative result set is provided in FIG. 1. First, a first search query is defined and stored 100, and a second search query is defined and stored 101. In the present example, it may be supposed that ‘COKE’ is the first search query 100, and ‘DIET COKE’ is the second search query 101. Second, the method of the present embodiment then submits the first query to one or more network accessible sources of information 102, such as an Internet search engine provided by YAHOO.COM or GOOGLE.COM, and also submits the second query to one or more network accessible sources of information 103, which may be the same as or different from those used for the first search query. Third, the current embodiment receives a first raw result set 104 from the queried sources, and receives a second raw result set 105 from the queries sources. The results are considered ‘raw’ because traditional search engines often provide results which have duplicate items or dead links.

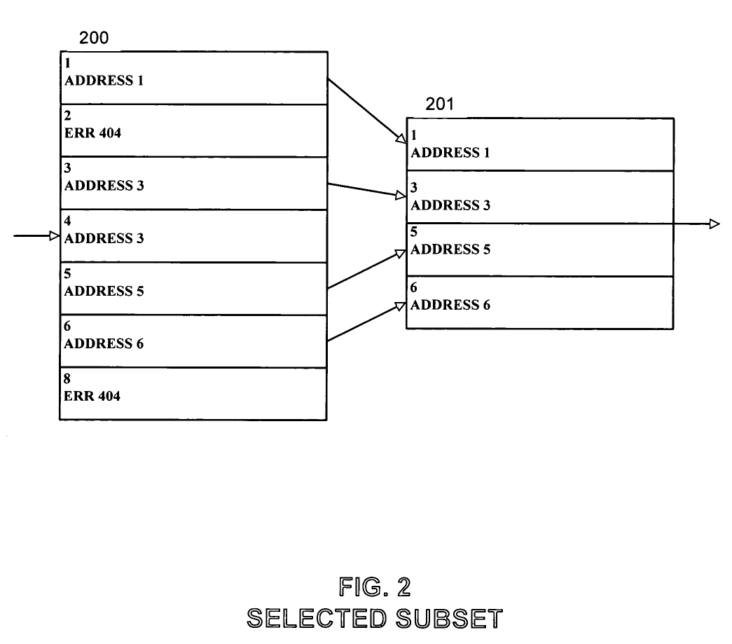

Fourth, a selected subset of the first raw result set is stored 106. FIG. 2 illustrates logically how a selected subset is formed in one embodiment of the present invention. First, raw search results are supplied 200 which contain duplicate items and results which no longer exist or have bad network addresses (here denoted by ‘ERR 404’, which is displayed in a web browser when an HTTP request is made for an item which no longer exist). Thus, this processing results in a subset 201 of the provided raw result set 200 which contains all or less than all items in the raw result set 200. The selected subset is very useful to the researcher because he knows that each result item is unique and corresponds to a network resource that currently exists.

Returning to the embodiment of FIG. 1, the first result set 106 and the second result set 107 each contain unique and currently existing items, and are stored for future use. Under the facts of the current example, the researcher has created a first result set 106 containing references for COKE, and a second result set 107 containing references for DIET COKE. Next, to form the cumulative result set, a function is executed 108 which has as its input at least the first and second result sets. The function of the current embodiment may include one or more set operation functions, such as select, project, join, union, intersection, and difference functions, and may also include one or more Boolean logic functions.

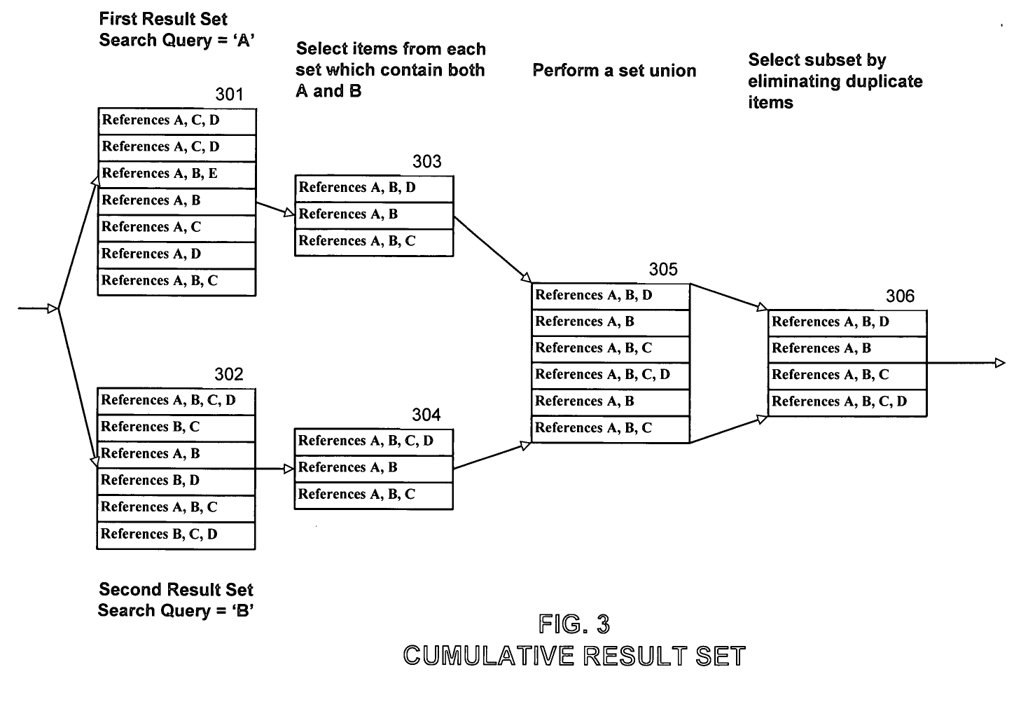

FIG. 3 provides a logical example of one embodiment of the present invention wherein the first result set 301 and the second result set 302 are processed by a function 108. For purposes of the present embodiment, ‘A’ stands for COKE, ‘B’ for DIET COKE, ‘C’ for PEPSI, and ‘D’ for DIET PEPSI. Thus, it is seen that the first result set 301 contains multiple items which reference COKE as well as other soft drinks, and the second result set 302 contains references to DIET COKE, as well as other soft drinks.

In the current embodiment, the researcher's goal is to combine the result sets for COKE (A) and DIET COKE (B), to determine only those items which contain references to both COKE and DIET COKE. To perform this operation, items are selected from the first result set which contain both A and B 303, and items are selected from the second result set which contain both A and B 304. Then, the function performs a set union, which combines the sets referenced by 303 and 304, producing the set 305. However, the set union may produce unwanted duplicate items which will distract the researcher. Thus, the current embodiment removes duplicate items in 305, producing a selected subset 306.

In the current embodiment, the user has queried search engines and stored a first result set for COKE, and a second for DIET COKE. Based on these stored result sets, the researcher has further combined the first and second result sets to produce a cumulative result set 109 of items which mention both COCA-COLA products. Further, since the current embodiment has processed items in the cumulative result set to remove dead and duplicate items, the researcher knows that cumulative result set contains valid and current items, enabling him to perform accurate network research.

As a second example utilizing the embodiment of FIG. 1, suppose the researcher wishes to perform competitive intelligence analysis for PEPSI products, such as PEPSI and DIET PEPSI. Here, the researcher wants to know current web sites which reference either PEPSI or DIET PEPSI. First, the researcher defines and stores a first search query 100 for PEPSI, and defines and stores a second search query 101 for DIET PEPSI. Second, the method of the current embodiment submits the fist query 102 and the second query 103 to one or more Internet search engines. Third, a first raw result set 104 and a second raw result set 105 are received from the network sources of information, which likely contain duplicate items or dead links. Fourth, the current embodiment processes the first 104 and second 105 raw result sets, as illustrated logically in FIG. 2, to remove the duplicate items and dead links, wherein the determined selected subsets are stored as the first result set 106 and the second result set 107, respectively.

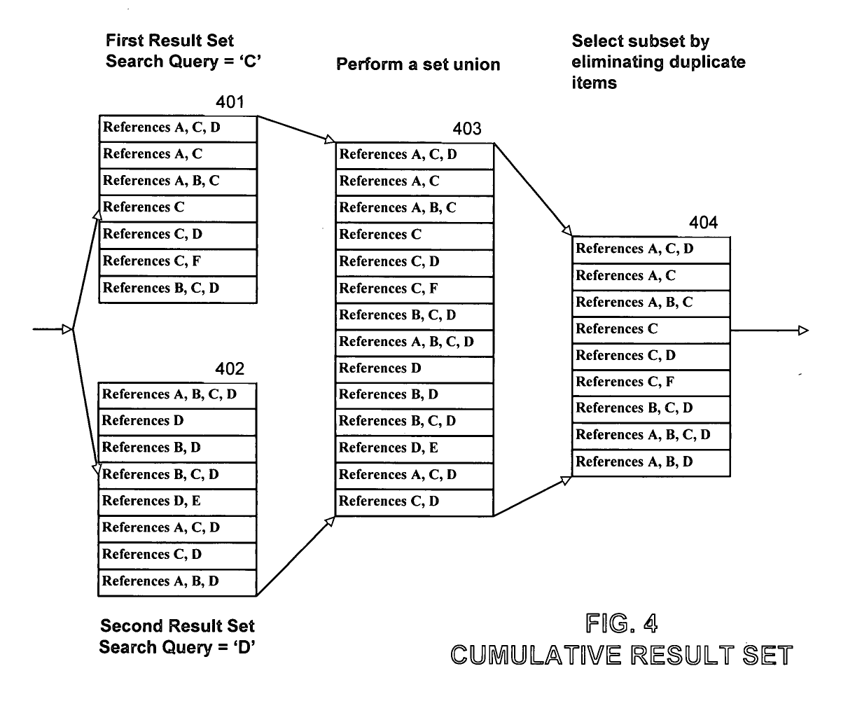

Fifth, a function is executed 108 which takes as its input at least the first and second result sets. The current example of the present embodiment is illustrated logically in FIG. 4, where it can be seen that the first result set 401 contains references to PEPSI (C) and the second result set 402 contains references to DIET PEPSI (D). Since the user wants to know all network addressable items which refer to at least one PEPSI product, the function 108 performs a set union, producing a set 403 which contains the sum of the first 401 and second 402 result sets. Next, the current embodiment determines a selected subset of the union 403, removing duplicate items to produce the cumulative result set 404.

Thus, in the current example of the present embodiment, the user has defined and stored result sets for individual PEPSI products, wherein each result set is independently useful for research, and has also created a cumulative result set of items which reference either of two PEPSI product, namely PEPSI or DIET PEPSI. This PEPSI product cumulative result set is useful, for example, where it provides the researcher with a current and valid list of results which reference at least one PEPSI product, allowing him to analyze brand recognition on the Internet, determine how many web sites reference a PEPSI product, etc.

### Research Using an Intelligent Result Set

In another embodiment of the present invention, a method is provided for facilitating network research using intelligent result sets. Intelligent result sets are useful for research by allowing a user to query network accessible sources of information, receive and store result sets, compare and contrast those result sets using set operations to create cumulative result sets, and then further comparing those cumulative result sets using set operations to define an intelligent result set. By storing and comparing cumulative result sets to produce intelligent result sets, the present invention allows the Internet to be used as a powerful database-like research tool, with functionality far beyond that of traditional search engines.

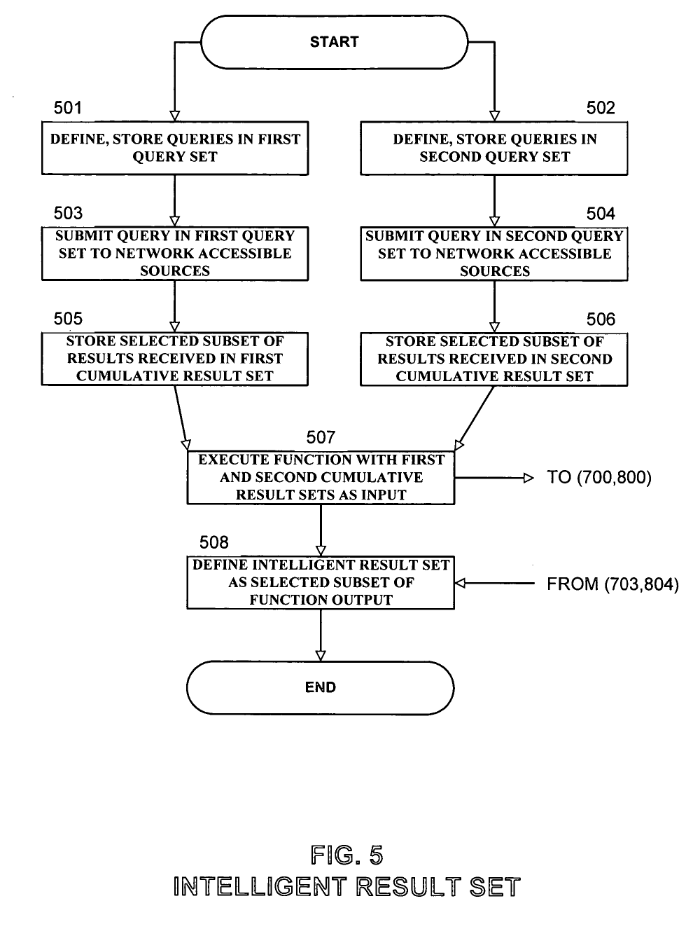

FIG. 5 provides a logical illustration of how an intelligent result set is determined in one embodiment of the present invention. First, the method of the current embodiment defines and stores one or more queries in a first query set 501, and defines and stores one or more queries in a second query set 502. Second, one or more queries in the first query set 501 and one or more queries in the second query set 502 are submitted (503, 504) to one or more network accessible sources of information, such as Internet search engines. Third, a selected subset of the results received from queries in the first query set are stored in a first cumulative result set 505, and a selected subset of the results received from the queries in the second query set are stored in a second cumulative result set 506. In the current embodiment, the first and second cumulative result sets may be formed by following the logical steps provided in steps 100 through 109 of the embodiment of FIG. 1, as discussed above.

Fourth in the current embodiment, the first and second cumulative result sets are input to a function 507. As discussed in the prior embodiments and illustrated in FIGS. 1 through 4, the researcher employing the method of FIG. 5 has defined the first search query as COKE (A), the second as DIET COKE (B), the third as PEPSI (C), and the fourth as DIET PEPSI (D). Additionally, the researcher has determined the first cumulative result set as illustrated in FIG. 3, wherein the first cumulative result set contains items which reference COKE (A) and DIET COKE (B), and has also determined the second cumulative result set as illustrated in FIG. 4, wherein the second cumulative result set contains references to PEPSI (C) or DIET PEPSI (D).

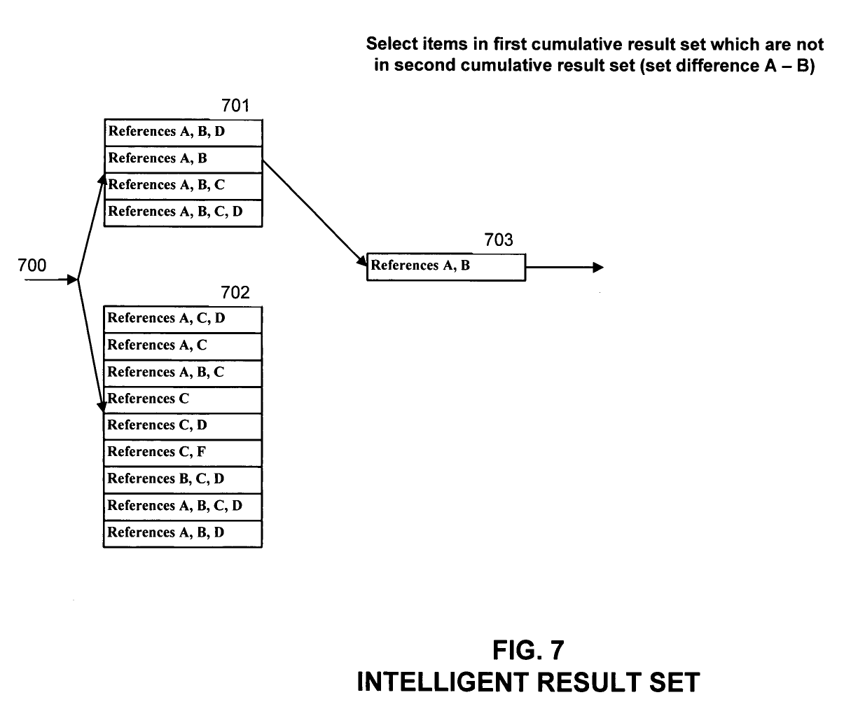

Fifth, in the current embodiment, the first 505 and second 506 cumulative result sets are provided to the function 507, wherein the function executes a set operation as logically illustrated in the embodiment of FIG. 7. In the embodiment of FIG. 7, the researcher wishes to determine those items which reference COKE (A) and DIET COKE (B), but do not reference either PEPSI product, PEPSI (C) or DIET PEPSI (D). Accordingly, the function 507 performs a difference function using the first cumulative result set 701 and the second cumulative result set 702. The result in the embodiment of FIG. 7 is only one item 703, which references COKE (A) and DIET COKE (B). In other words, the researcher has determined that out of the four items in the first cumulative result set 701 which referenced both COCA-COLA products, only one of those items did not mention any PEPSI product. Thus, the researcher has defined the intelligent result which reveals the sole item which references both COCA-COLA products, and references no PEPSI product.

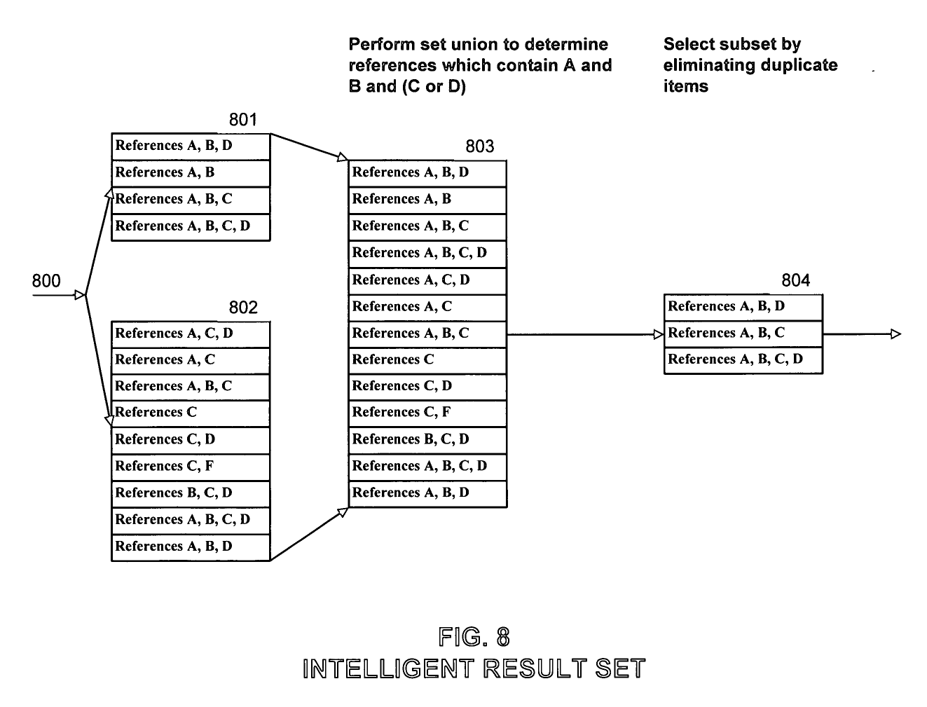

Similarly, in the embodiment illustrated in FIG. 8, the researcher wishes to determine web sites which reference both COCA-COLA products, and at least one PEPSI product. Here, the first cumulative result set 801 and the second cumulative result set 802 are provided to the function 507, which executes a set union function, producing the set 803. Next, duplicate items are eliminated, producing the set 804, which is the selected subset 508 in the embodiment of FIG. 5. Thus, the researcher has utilized the four stored result sets to determine the intelligent result set 804, which reveals the three web sites which refer to both COKE (A), DIET COKE (B), and at least one PEPSI product, namely PEPSI (C) or DIET PEPSI (D). This information also tells the researcher that out of the four items which reference both COCA-COLA products, three of those items reference at least one PEPSI product, indicating that not many web sites only reference COCA-COLA products.

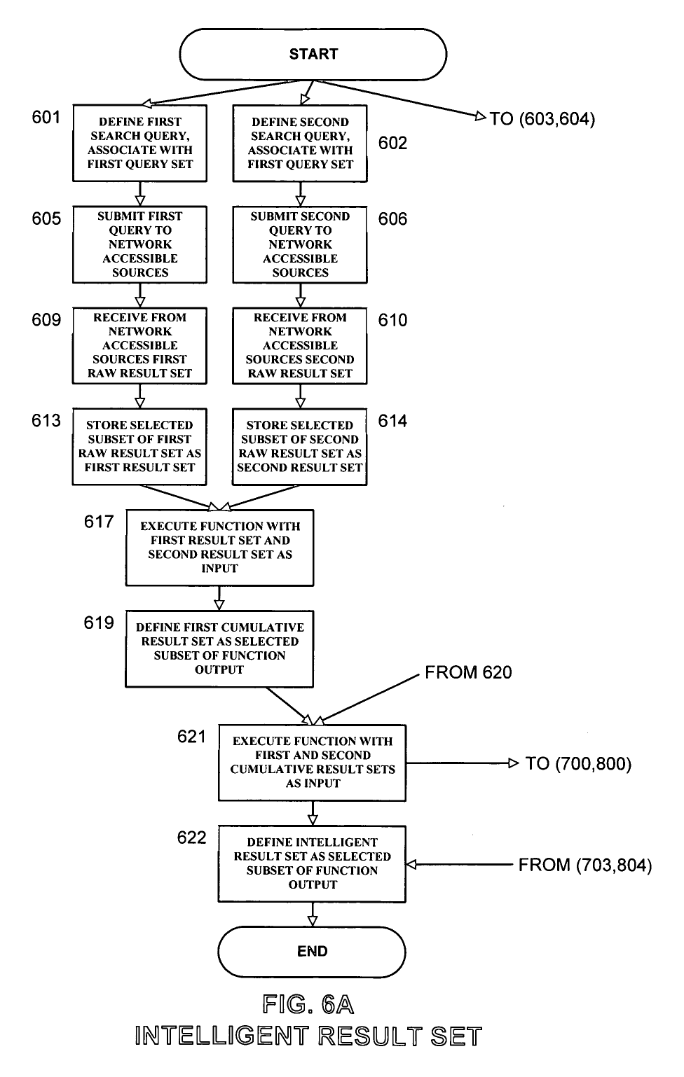

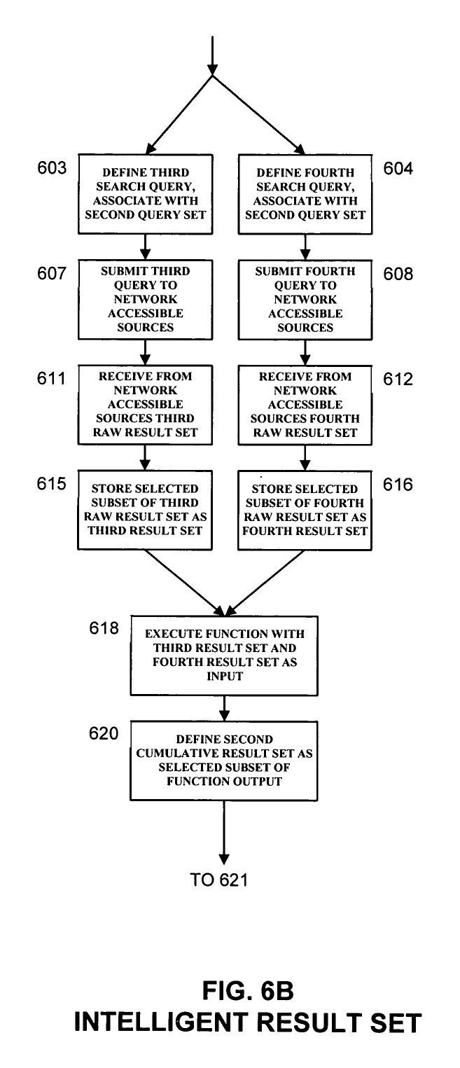

FIG. 6 illustrates another embodiment for determining an intelligent result set, wherein at least four result sets are used. In the embodiment of FIG. 6, the exemplary facts of the prior embodiments will be used for illustration. First, a first search query 601, second search query 602, third search query 603, and fourth search query 604 are determined by the user. These queries are then submitted to one or more network accessible sources of information at steps 605-608, and where the first through fourth raw result sets are received in steps 609-612. Then, for each raw result set 609-612, a corresponding result set 613-616 is determined as a selected subset of each raw result set 609-612. The selected subsets of the current embodiment can be determined as logically illustrated in FIG. 2, where duplicate items and dead links are removed.

Next in the embodiment of FIG. 6, the first and second result sets are input to a function 617, as well as the third and fourth result sets 618. Then, the first cumulative result set 619 and second cumulative result set 620 are each determined as a selected subset of their respective function outputs 617, 618. A further function is then executed 621 with the first 619 and second 620 cumulative result sets as input. For illustrative purposes, the embodiments of FIG. 7 and FIG. 8 show the determination of an intelligent result set as useable in the embodiment of FIG. 6, resulting in the determination of an intelligent result set 622 from the four stored result sets.

### Facilitating Research Using Annotation Objects

In another embodiment of the present invention, a method is provided which allows a researcher to make notes, or annotations, and associate them with one or more items, or web site ‘hits’. The ability to annotation search results is useful for those who wish to use the Internet as a true library-like research tool.

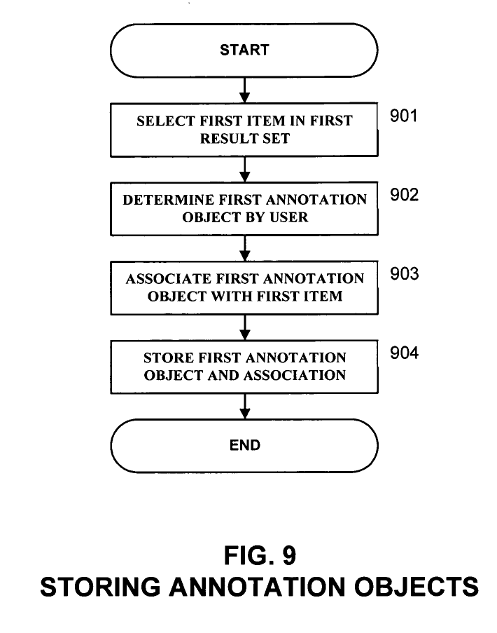

FIG. 9 illustrates the logical view of one embodiment of the present invention useful for storing annotation objects. First, a first user selects an item in a first result set 901, which contains one or more items. Second, the user determines a first annotation object 902, which will comprise the user's ‘note’ concerning a particular search result. In the embodiment shown in FIG. 9, an annotation object can include text, graphics, sound, animated graphics, video, applets, executable code, or any other object which allows the user to store information relevant to a search result.

Third, the user associates the annotation object with a particular search result item 903, linking the annotation with the result item. Finally, the method stores the annotation object and the association 904, so that the user's annotation will persist for later use.

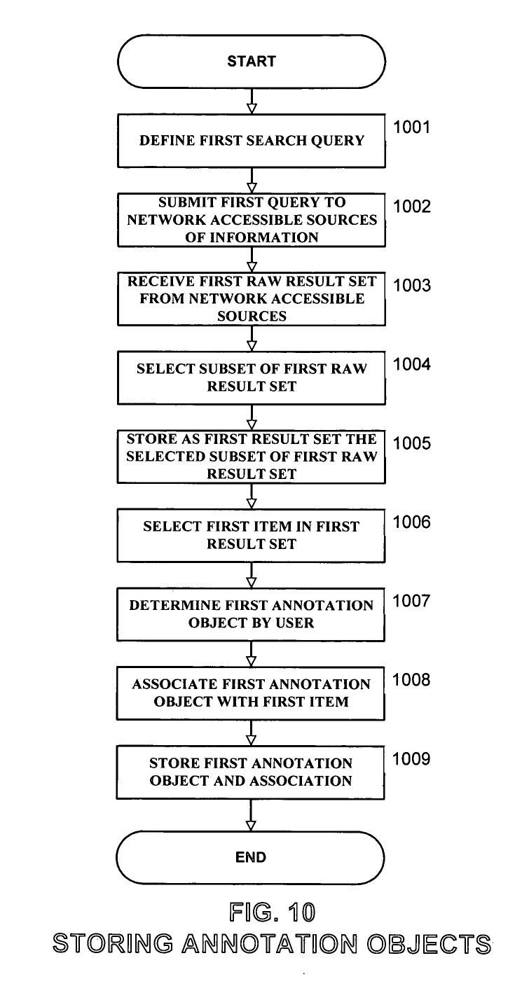

The embodiment of FIG. 10 illustrates another method which allows a user to store an annotation object. In this embodiment, the user defines a search query 1001 such as ‘COKE’. Second, the method submits the search query to a network accessible source of information 1002, such as an Internet search engine. Third, the queried Internet search engines return one or more raw result sets 1003, which likely contain duplicate items and dead links. Fourth, the method of the present embodiment selects a subset of the raw result sets, using a method like that depicted in FIG. 2, wherein duplicate items and dead links are eliminated.

Next, the current embodiment stores the selected subset 1004 as the first result set 1005, providing the user with a result set of unique and current search results. After reviewing one or more results, the user determines a result that is very helpful for his research. Accordingly, the user wants to store a digital note or annotation regarding the first result, to mark the first result so it can be quickly identified later. To this end, the user wishes to create an annotation object containing the text “Great Site” associated with the first result.

To this end, the user selects the first item 1006 he wishes to annotate, and then creates an annotation reading “Great Site” 1007, for example. Then, he associates the annotation with the first item 1008. Finally, to provide a persistent ‘note’ regarding the first item, the current embodiment stores the annotation and the item-annotation association 1009. Now that the hypothetical researcher used to illustrate the various embodiments has annotated a particularly good search result, he can return at a later time, where his annotation will remind him of the usefulness of the result.

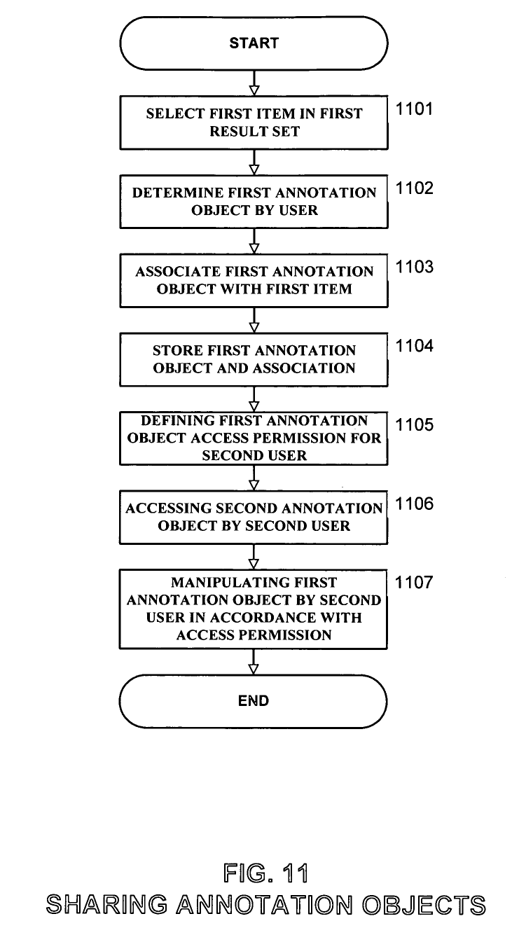

Often, multiple users collaborate to perform research. To this end, traditional library researchers often annotate a particular result of interest, and then share that annotation with another researcher so that the second researcher can benefit from the research work already done by the first researcher. The embodiment illustrated in FIG. 11 of the present invention provides a means for a first researcher to make and store annotations, and then share those annotations with a second researcher in a controlled manner.

In the embodiment of FIG. 11, the first user selects a first item in a first result set 1101. Second, the first user determines a first annotation object 1102, such as a text object reading “Great Site—Study Later”. Third, the first user associates the first annotation object with the first item 1103, here a particular result produced by an Internet search engine. The method of the current embodiment then stores the first annotation object and the annotation-object association 1104.

Fifth, the first user defines a first annotation object access permission 1105, which defines the level of access a second researcher will have to the first user's digital ‘note’, or annotation. Here, for example, the access permission grants the second user the ability to modify the first annotation object. Accordingly, the second user accesses the annotation object 1106, and manipulates the annotation object in accordance with the access permission. Here, for example, the second user changes the annotation to read “Reviewed Site—Contains No Useful Information”. Later, when the first user views the annotation, he will see that the second user has investigated the annotated result and determined that it's not of great value. Therefore, the embodiment of FIG. 11 has allowed the fist and second users to conduct collaborative network research and provided the ability for them to communicate their findings by sharing annotation objects.

### Sharing Research through Item Collaboration

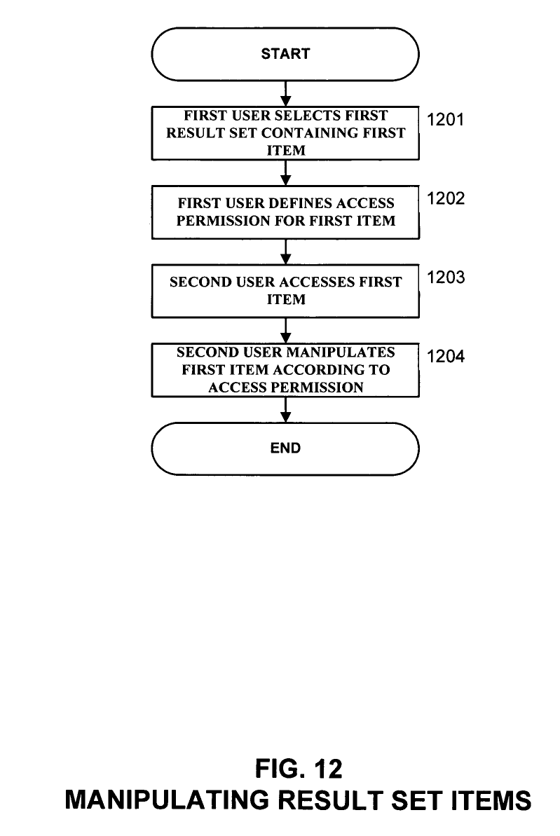

An essential ability useful in collaborative research is the ability for numerous researchers to add, remove, or change stored search results. The embodiment of FIG. 12 illustrates a method which allows network researchers to collaboratively share search results. First, the first user selects a first result set containing a first result item 1201. Second, the first user defines an access permission for the first item 1202, enabling the first user to share the first item 1201 in a predetermined manner. Third, the second user accesses the first item 1203, and manipulates the first item according to the access permission 1204 established by the first user 1202. Here, for example, the first user selected the access permission to give the second user an ability to add or remove the first item. Accordingly, at step 1204, the second user reviewed the first item, determined that it was of little value, and deleted it from the first result set.

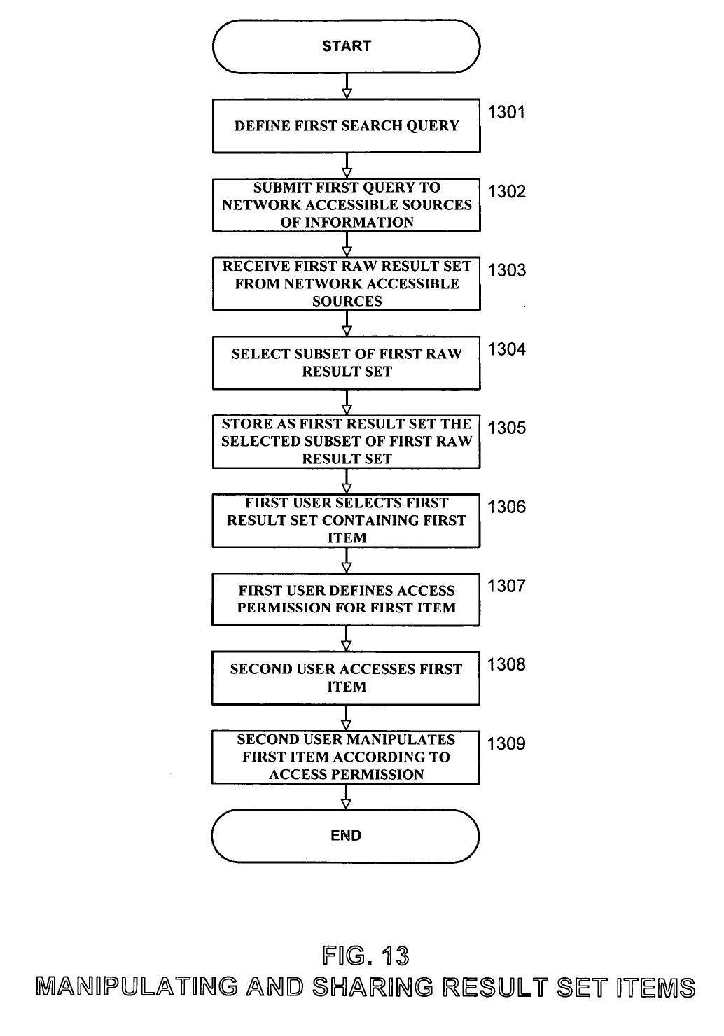

FIG. 13 provides another embodiment which allows a first researcher to share a search result item with a second researcher in a controlled fashion. First, in the embodiment of FIG. 13, a first search query is defined 1301 by the first user. Second, the method of FIG. 13 submits the first query to one or more network accessible sources of information 1302. Third, the method receives a first raw result set from the network sources 1303, and selects a subset of the first raw result set 1304. Determining a selected subset is logically illustrated in the embodiment of FIG. 2.

Next, the first user selects a first result set containing a first result 1306 of interest. Then, the first user defines an access permission for the first item 1307. Here, the first user decides that a second user should have read-only access to the first result. Then, the second user accesses the first item 1308, and manipulates the first item according to the access permission 1309 determined by the first user. Accordingly, the access permission here allows the second user to read, but not change, the first result according to the read-only access permission.

### Sharing Research through Search Group Collaboration

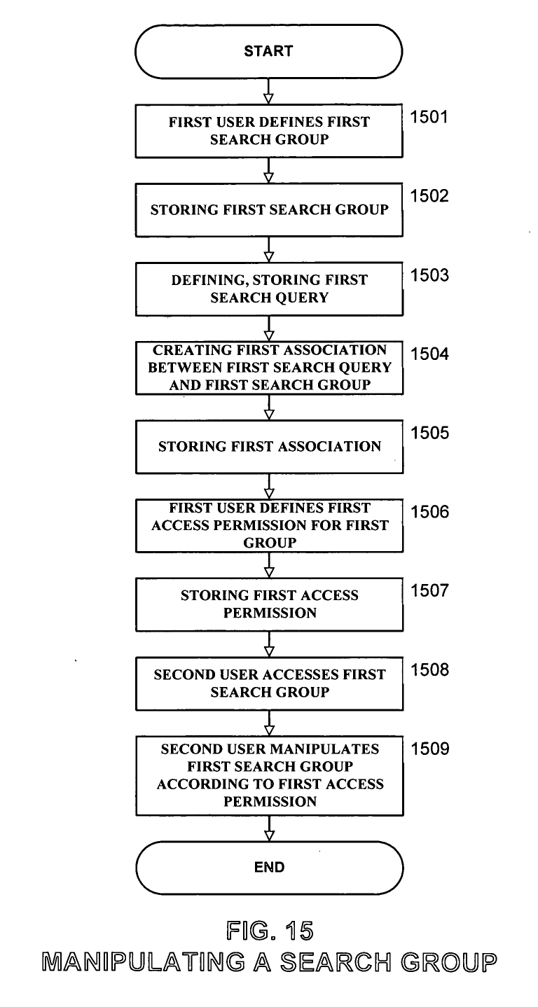

FIG. 15 illustrates one embodiment of the present invention whereby a first user wishes to share a search group in a controlled manner. In the embodiment of FIG. 15, a search group comprises a first query and an associated first result set.

First, in the embodiment of FIG. 15, the first user defines a first search group 1501. For example, the first user wishes to create queries and receive results regarding soft drinks, so the first user creates a first group “Soft Drinks”. Second, the method of the current embodiment stores the first search group 1502. Third, the first user defines a first search query 1503, such as “COKE”, which is then stored. Fourth, a first association is created between the first search query and the first search group 1504, such that the first search group ‘contains’ the first search query. Fifth, the first association is then stored 1505.

Sixth, the first user defines a first access permission for the first group 1506, which defines the level of access a second user has to the first search group. Then, the method stores the first access permission 1507. Next, the second user accesses the first search group 1508, and manipulates the first search group according to the first access permission. Here, for example, the first user wishes to give the second user the ability to read and change anything associated with the first search group. The first user had selected the first query 1503 to be “COKE”, and defined the access permission for the entire “Soft drink” group to be read-write. Accordingly, when the second user views the first search group, he sees the first query 1503, and decides that it needs changing. Thus, according to the search group “Soft Drinks” access permission 1506, the second user changes the first query 1509 to be “COKE and PEPSI and SPRITE”.

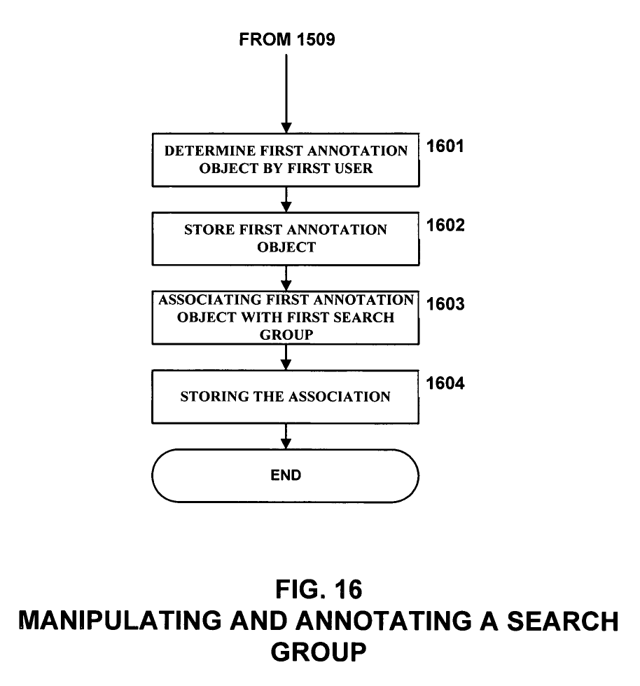

FIG. 16 provides another embodiment for manipulating a search group by a second user, wherein the first user wishes to store annotations regarding the first search group. Here, for example, the first user wants to store a note regarding the first search group, reading “Soft Drink Group—Use for Homework Assignment”. First, at step 1601, the first user determines a first annotation object. Second, the method stores the first annotation object 1602. Third, the first user associates the first annotation object with the first search group 1603, causing the current embodiment to store the group-annotation association 1604.

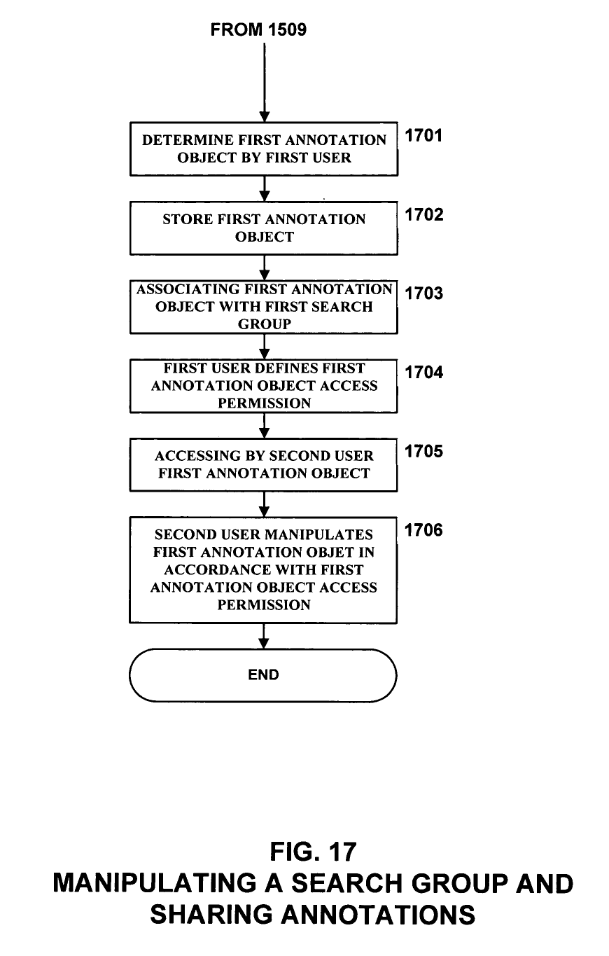

FIG. 17 provides a further embodiment for manipulating a search group by a second user, wherein the first user wishes to store and share annotations regarding the first search group. Here, for example, the first user wants to store a note regarding the first search group, reading “Soft Drink Group—Use for Homework Assignment”, and share that note with a second user according to an access permission.

First, at step 1701, the first user determines a first annotation object. Second, the method stores the first annotation object 1702. Third, the first user associates the first annotation object with the first search group 1703. Fourth, the first user defines a first annotation object access permission 1704, for example, giving the second user read-only access to the first annotation object. Then, the second user accesses the fist annotation object 1705, for example, to help the first user complete his homework assignment. The second user then manipulates 1706 the first annotation object according to the access permission 1704. Here, for example, the second user reads can read queries or results in the first search group, but cannot change them, as a result of the read-only access permission 1704 created by the first user.

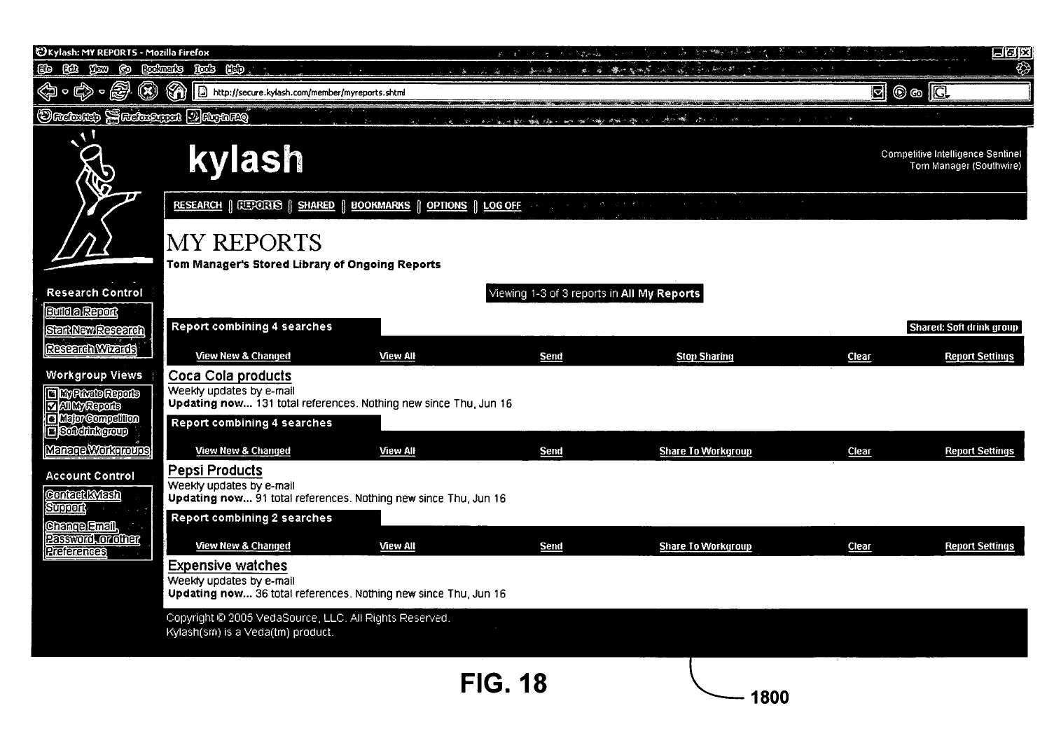

Multiple screen shots representing web pages from the KYLASH.COM web site illustrate various embodiments of the present invention. For example, FIG. 18 at 1800 shows a screen capture of one embodiment of the present invention, illustrating search groups for “Coca Cola Products”, “Pepsi Products”, and “Expensive Watches”. Further, the “Coca Cola Products” search group is shared with a plurality of users and contains four search queries and result sets, combinable to produce one or more cumulative or intelligent result sets.

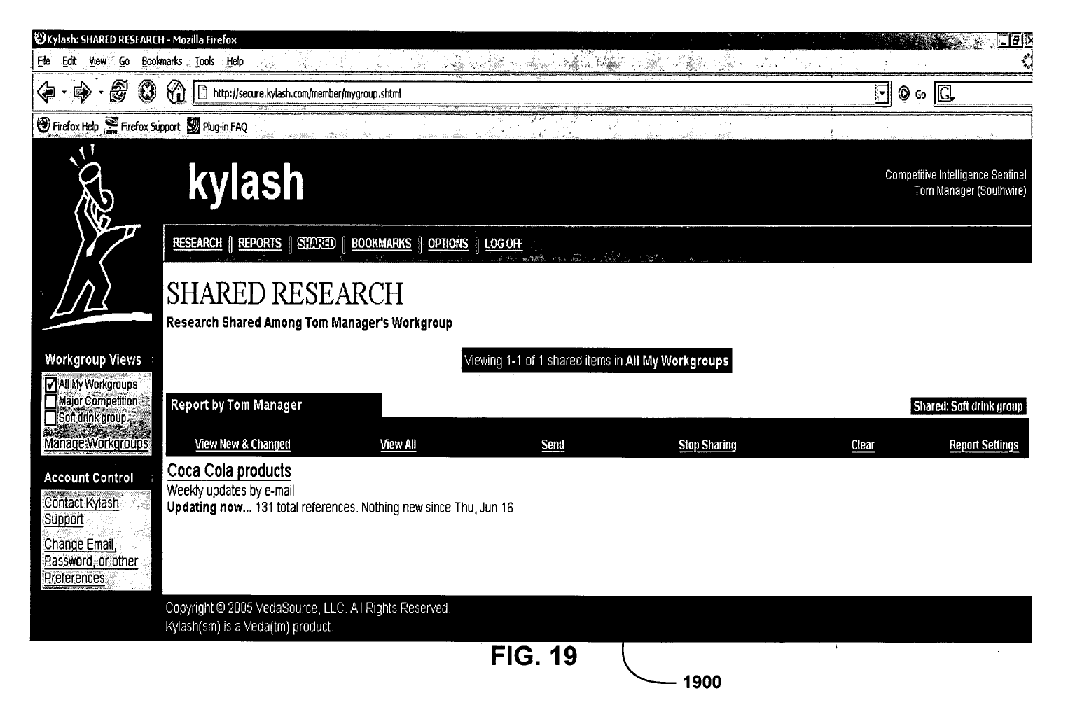

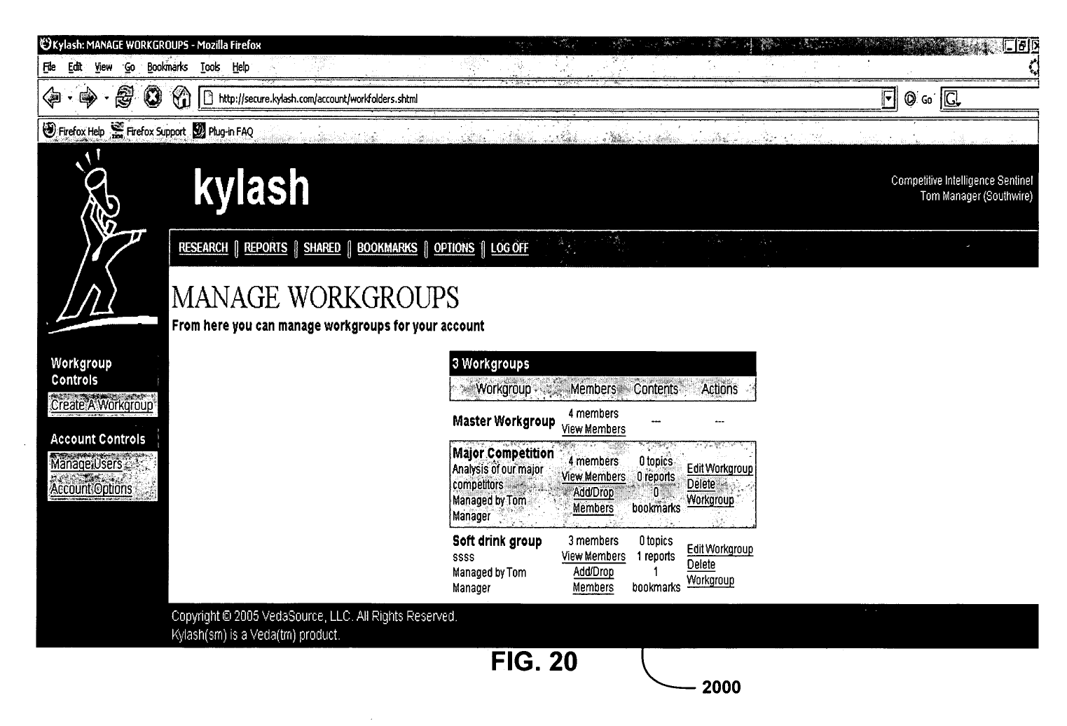

FIG. 19 at 1900 shows a screen capture of one embodiment of the present invention, illustrating a search group and result set sharing. FIG. 20 at 2000 also illustrates search group sharing as well as search group annotations, here “Analysis of our major competitors.”

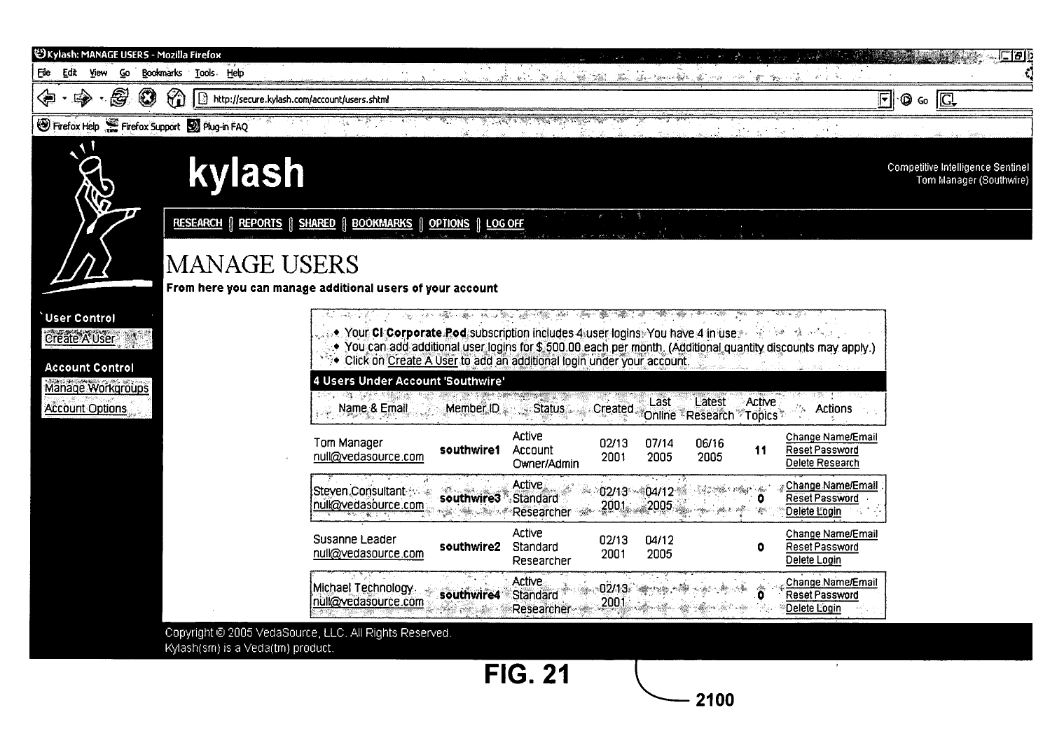

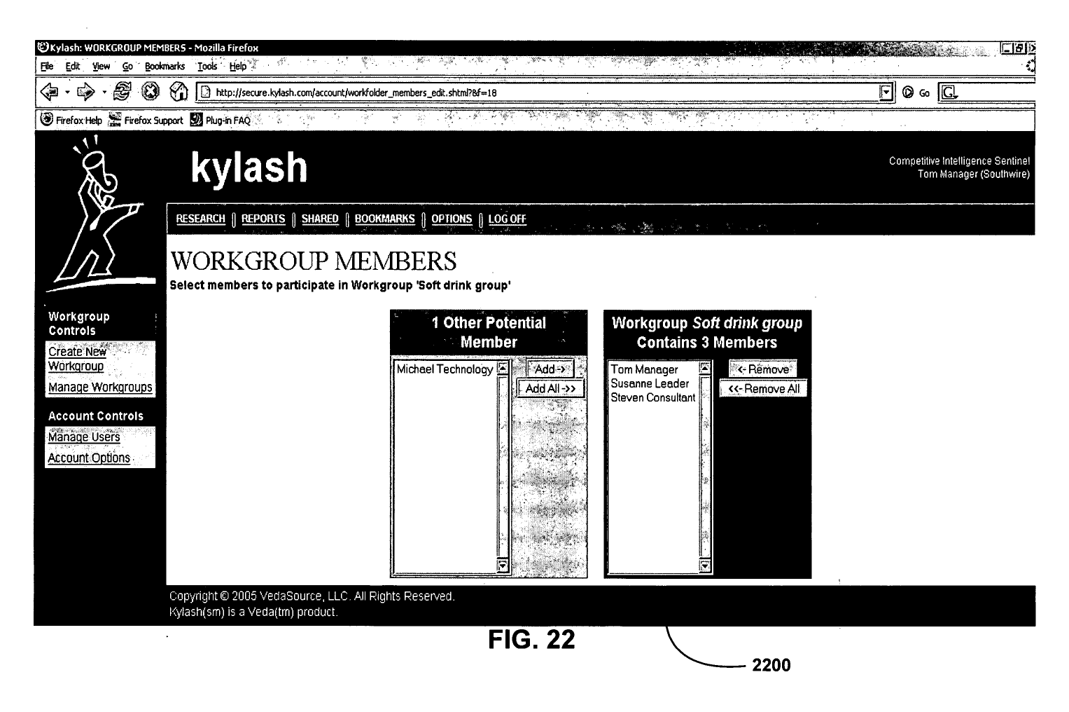

The management of users for collaborative research is shown at 2100 of FIG. 21, which illustrates multiple research users and their individual access permissions. For example, “Tom Manager” is an “Owner/Admin’, whereas “Steven Consultant” is only a “Researcher”. FIG. 22 at 2200 shows a related embodiment wherein the present invention allows a first user to add or remove users in the search group.

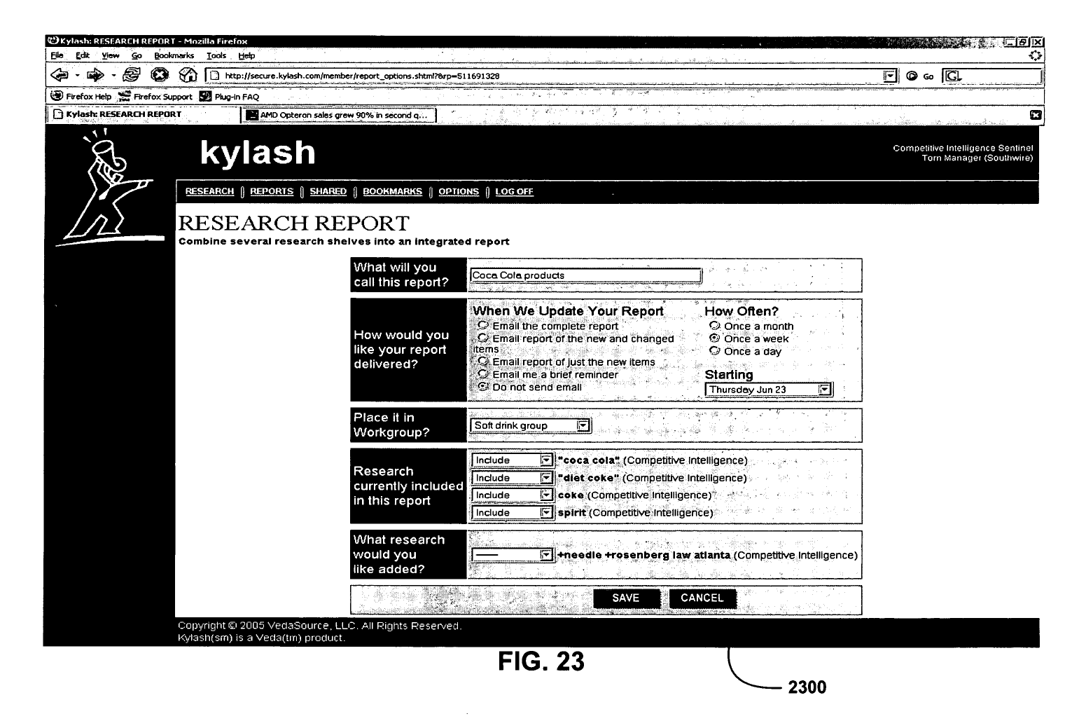

FIG. 23 at 2300 shows a screen capture of one embodiment of the present invention, illustrating search queries such as “coca cola” and “diet coke”, and the combination of the corresponding search results into one or more cumulative result sets or intelligent result sets, allowing a user to conduct competitive intelligence analysis for COCA-COLA soft drink products. This embodiment also illustrates the ways in which the results can be communicated to a researcher, such as by email.

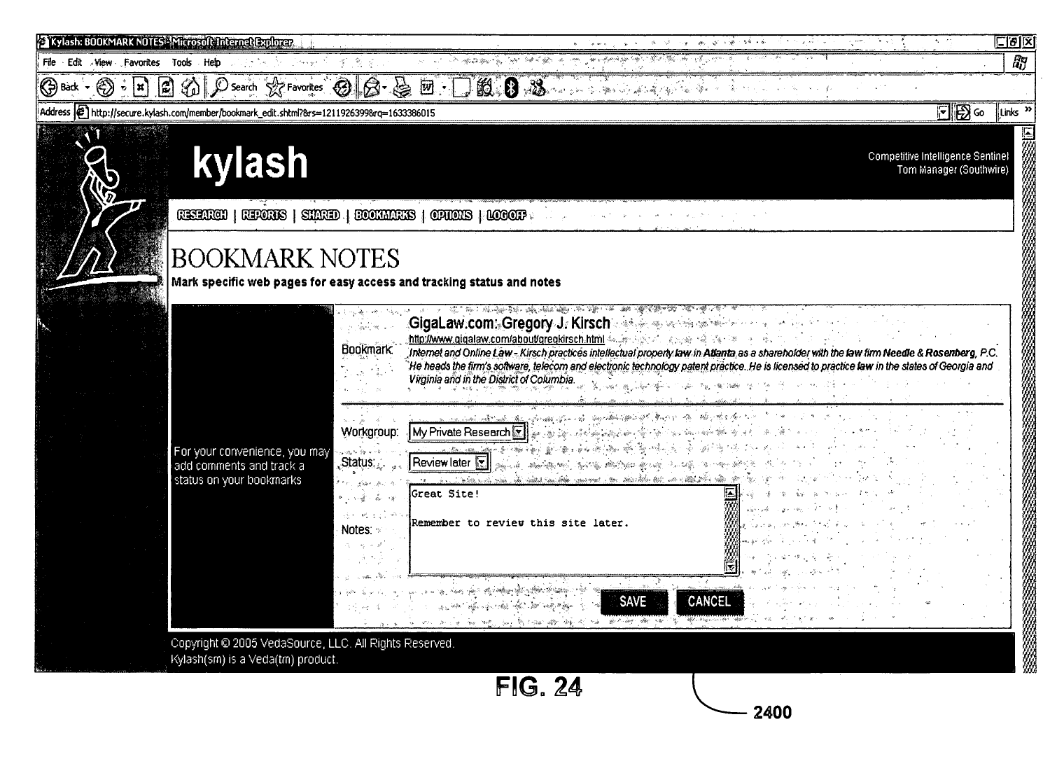

2400 of FIG. 24 shows a screen capture of one embodiment of the present invention, illustrating a search group or work group titled “My Private Research”. A textual annotation object is shown associated with the result item titled “GigaLaw.com: Gregory J. Kirsch”. Here, after entering annotation text reading “Great Site! Remember to review this site later.” the user can store the annotation and the annotation-item association by clicking on the “SAVE” button shown in the user's Internet web browser.

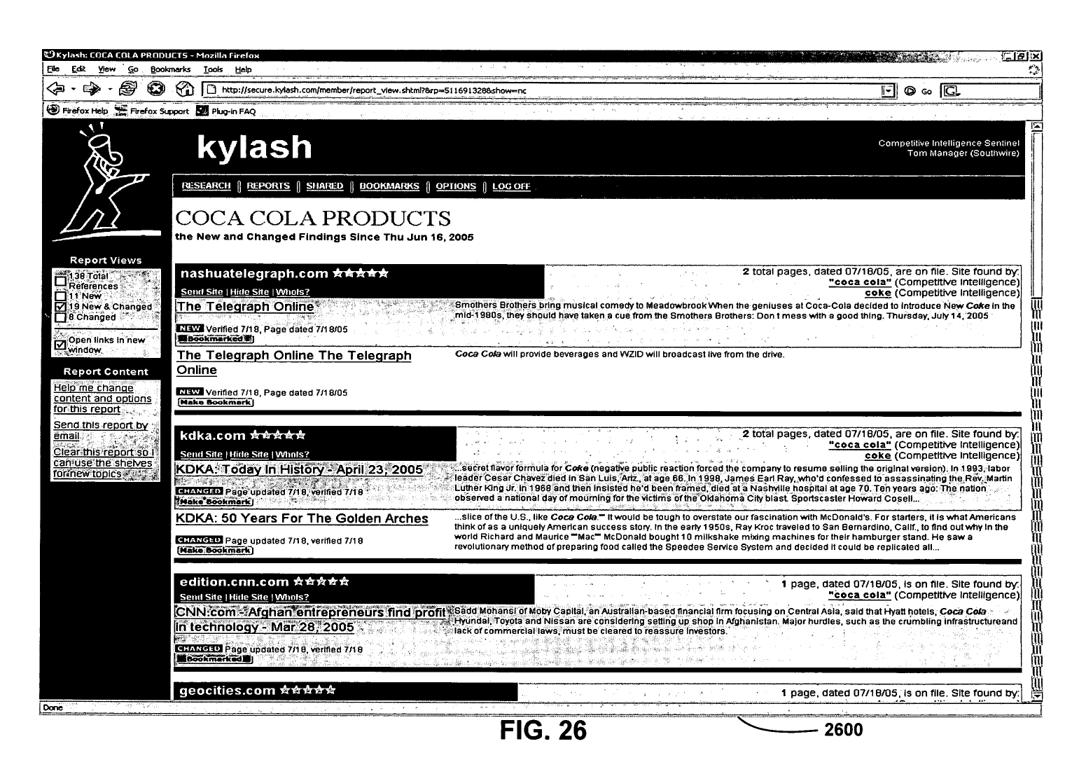

FIG. 26 at 2600 shows a screen capture of one embodiment of the present invention, showing the search group “COCA COLA PRODUCTS”, the verification of result set items as illustrated by “Verified 7/18”, annotation objects such as “Make Bookmark”, and the storage of search results. Stored search queries “coca cola” and “coke” are also shown, as well as the cumulative result set communicated to a user in a web browser.

The present invention has been illustrated in relation to embodiments which are intended in all respects to be illustrative rather than restrictive. Those skilled in the art will realize that the present invention is capable of many modifications and variations without departing from the scope of the invention.

We claim:

1. A method for storing annotation objects, comprising the steps of:
a. selecting, by a first user, a first result set containing at least a first item which is associated with a network address;
b. determining, by the first user, a first annotation object;
c. associating, by the first user, the first annotation object with the first item in the first result set; and
d. storing the first annotation object and the association.

2. The method of claim 1, further comprising the steps of:
a. defining a first search query;
b. submitting the first search query to one or more network accessible sources of information;
c. receiving, from the one or more network accessible sources of information, as a result of submitting the first search query, a first raw result set, wherein the first raw result set contains items which are associated with network addresses; and
d. storing, as a first result set, a selected subset of the first raw result set.

3. The method of claim 1, wherein the network includes the Internet, network addresses include Uniform Resource Locators (URLs), network accessible sources of information include network searchable sources of information, and items include result listings returned from network accessible sources of information.

4. The method of claim 1, wherein an annotation object comprises at least one of a text object, or graphic object, or sound object, or video object, or animation object, or executable code object.

5. The method of claim 1, further comprising the steps of:
a. defining, by the first user, a first annotation object access permission, wherein the first annotation object access permission defines the level of access that a second user has to the first annotation object;
b. accessing, by the second user, the first annotation object; and
c. manipulating, by the second user, the first annotation object in accordance with the first annotation object access permission.

6. A method for manipulating result set items, comprising the steps of:
a. selecting, by a first user, a first result set containing at least a first item which is associated with a network address;
b. defining, by the first user, a first access permission which defines a level of access a second user has to the first item;
c. accessing, by the second user, the first item; and
d. manipulating, by the second user, the first item in accordance with the first access permission.

7. The method of claim 6, further comprising the steps of:
a. defining by the first user a first search query;
b. submitting the first search query to one or more network accessible sources of information;
c. receiving, from the one or more network accessible sources of information, as a result of submitting the first search query, a first raw result set, wherein each result comprises at least one item associated with a network address; and
d. storing, as the first result set, a selected subset from the first raw result set.

8. The method of claim 6, wherein the network includes the Internet, network addresses include Uniform Resource Locators (URLs), network accessible sources of information include network searchable sources of information, and items include result listings returned from network accessible sources of information.

9. The method of claim 6, further comprising the steps of:
a. defining a first search group, wherein a search group comprises an association with one or more search result sets;
b. storing the first search group;
c. associating, by the first user, the first result set with the first search group; and
d. storing the association between the first result set and the first search group.

10. A method for manipulating a search group, comprising the steps of:
a. defining, by a first user, a first search group, wherein the first search group can be associated with one or more search queries;
b. storing the first search group;
c. defining and storing a first search query;
d. creating a first association between the first search query and the first search group;
e. storing the first association;
f. defining, by the first user, a first access permission which defines a level of access a second user has to the first search group;
g. storing the first access permission;
h. accessing, by the second user, the first search group; and
i. manipulating, by the second user, the first search group in accordance with the first access permission.

11. The method of claim 10, wherein the network includes the Internet, network addresses include Uniform Resource Locators (URLs), network accessible sources of information include network searchable sources of information, and items include result listings returned from network accessible sources of information.

12. The method of claim 10, further comprising the steps of:
a. determining, by the first user, a first annotation object;
b. storing the first annotation object;
c. associating, by the first user, the first annotation object with the first search group; and
d. storing the association.

13. The method of claim 12, wherein an annotation object comprises at least one of a text object, or graphic object, or sound object, or video object, or animation object, or executable code object.

14. The method of claim 12, further comprising the steps of:
a. defining, by the first user, a first annotation object access permission, wherein the first annotation object access permission defines the level of access that the second user has to the first annotation object;
b. accessing, by the second user, the first annotation object; and
c. manipulating, by the second user, the first annotation object in accordance with the first annotation object access permission.
